(19) United States
(12) Patent Application Publication
(10) Pub. No.: US 2023/0173785 A1
(43) Pub. Date: Jun. 8, 2023

(54) VACUUM INSULATION PANEL

(71) Applicant: VA-Q-TEC AG, Würzburg (DE)

(72) Inventors: Joachim KUHN, Würzburg (DE); Tobias BOCK, Kitzingen (DE); Kerstin MÜLLER, Würzburg (DE); Slava LEJA, Geiselwind (DE); Hendrik FEUERSTEIN, Würzburg (DE)

(21) Appl. No.: 18/075,816

(22) Filed: Dec. 6, 2022

(30) Foreign Application Priority Data
Dec. 7, 2021 (DE) 10 2021 132 179.4

(51) Int. Cl. B32B 3/04; E04B 1/80; B32B 5/02; B32B 17/02; B32B 33/00

(52) U.S. Cl. CPC B32B 3/04; E04B 1/803; B32B 5/024; B32B 5/026; B32B 17/02; B32B 33/00; B32B 2264/1026; B32B 2262/101; B32B 2255/20; B32B 2255/02; B32B 2315/08; B32B 2315/10; B32B 2305/182; B32B 2305/188; B32B 2305/30; B32B 2307/304; B32B 2307/3065

(57) ABSTRACT

It is an object of the invention to provide a heat-resistant vacuum insulation panel having two heat-resistant protective layers to improve fire protection, in particular at locations of the vacuum insulation panel subject to mechanical stress.

The present invention relates to a vacuum insulation panel having the features of the preamble of claim 1.

Vacuum insulation panels are used, for example, for efficient insulation of refrigerators and freezers as well as for insulation of transport containers for temperature-sensitive goods or for subsequent insulation in building renovation.

A vacuum insulation panel usually has a planar/sheet-like core of open-pored material and an enclosure that encloses the core tightly, completely and gas-tight on all sides. This makes it possible to evacuate the space inside the enclosure and in this way to bring the thermal conductivity of the vacuum insulation panel to very low values.

DE 10 2016 013 199 A1, which forms the starting point of the invention, discloses such a vacuum insulation panel.

For certain applications, for example in the building industry or in vehicle construction, high fire protection requirements must be met. Therefore, DE 10 2016 013 199 A1 provides an additional protective layer for the vacuum insulation panel, which has a heat-resistant material, and which is arranged on the outside in at least a region in order to meet the fire protection requirements.

The heat-resistant protective layer essentially consists of mica particles fixed with a binder. For optimized handling, the mica particles are applied and fixed to a planar/sheet-like carrier material, in particular a glass fiber fabric. Synthetic resin or synthetic rubber is used as binder.

The mica particles are bonded by the binder to either the inner or outer layer or to both the inner and outer layers. However, the binder does not completely saturate the layer with the mica particles, which is why the mica particles in the center of the heat-resistant layer are held together only by the weak Van der Waals bonds. In practice, the heat-resistant layer therefore has only a low cohesive strength, in particular less than 0.1 N/mm².

If a vacuum insulation panel is attached mechanically, for example by gripping around it, the low cohesive strength of the heat-resistant protective layer is not a problem, since only low shear forces and/or peeling forces act on the enclosure of the vacuum insulation panel and/or the heat-resistant protective layer.

Particularly in the case of adhesive attachment of the vacuum insulation panel and/or adhesive attachment of an object to the vacuum insulation panel to or on the heat-resistant protective layer, delamination and/or cohesive fracture of the heat-resistant protective layer can occur in practice, since the occurring peeling forces and/or shearing forces cannot be absorbed by the heat-resistant protective layer. This effect increases with increasing thickness and/or increasing number of layers/plies of the heat-resistant protective layer.

Against this background, it is an object of the present invention to provide an improved vacuum insulation panel with a heat-resistant enclosure, in particular wherein an improvement in fire protection can be achieved and/or greater peeling forces and/or shearing forces can be absorbed.

The above object is solved by a vacuum insulation panel according to claim 1. Preferred embodiments and further developments are the subject of the sub-claims.

The vacuum insulation panel preferably has a core made of an open-pored material and a gas-tight enclosure enclosing the core, preferably wherein the enclosure has a gas-tight barrier layer, an optional intermediate layer and, at least in some areas/regions, preferably over the entire surface, a first heat-resistant protective layer.

For the vacuum insulation panel, it is provided that the enclosure—in particular in addition to the first heat-resistant protective layer—has a second heat-resistant protective layer at least in some/certain areas/regions, preferably at least on the edges of the enclosure and/or on the flaps/tabs of the vacuum insulation panel or over the entire surface.

The second heat-resistant protective layer preferably forms, at least in some/certain areas/regions, the outermost layer and/or the outer surface of the vacuum insulation panel and/or enclosure.

Preferably, the second heat-resistant protective layer is arranged—in particular over an area, on the edges of the vacuum insulation panel and/or the enclosure and/or on the flaps/tabs of the vacuum insulation panel—on the outside of the barrier layer, on the optional intermediate layer, the first heat-resistant protective layer and/or a cover layer located on the outside of the first heat-resistant protective layer.

The second heat-resistant protective layer improves the fire protection and the mechanical stability/load-bearing capacity of the vacuum insulation panel and/or the enclosure compared to the prior art and/or to vacuum insulation panels with only one heat-resistant protective layer. In particular, an increase in the fire protection of the vacuum insulation panel is achieved. Furthermore, due to the second heat-resistant protective layer, greater peeling forces and/or shearing forces can be absorbed.

The first heat-resistant protective layer, hereinafter always referred to as first protective layer, serves in particular to improve the heat resistance of the vacuum insulation panel and/or to meet the fire protection requirements placed on the vacuum insulation panel.

The second heat-resistant protective layer, hereinafter always referred to as second protective layer, also serves to improve the heat resistance of the vacuum insulation panel and/or to meet the fire protection requirements placed on the vacuum insulation panel, but shall in addition improve the mechanical stability/load-bearing capacity of the vacuum insulation panel and/or the enclosure by the second protective layer protecting the first protective layer from external influences.

Preferably, the second heat-resistant protective layer has increased mechanical stability/load-bearing capacity compared to the first protective layer.

In particular, the second protective layer is stronger, stiffer, harder, more thermally conductive and/or less elastic than the first protective layer, in particular even at high temperatures, for example of more than 200° C., 400° C. or 600° C.

Preferably, the first protective layer is in the form of a film and/or the second protective layer is in the form of a varnish, in particular an intumescent fire protection varnish.

Preferably, the second protective layer distributes the forces and/or pressures acting on it, in particular a high surface load, which occurs, for example, in the case of adhesive attachment to small contact areas, evenly over the first protective layer and/or the interface between the second protective layer and the layer(s) immediately adjacent to the second protective layer.

The second protective layer can form the outside/outer face of the vacuum insulation panel in some regions or partially or over the entire surface and/or be arranged on the outside of the barrier layer, the optional intermediate layer, the first protective layer and/or the optional cover layer.

Preferably, the second protective layer is arranged at least in the outer regions of the vacuum insulation panel that are exposed to particularly large peeling forces and/or shearing forces and/or a high heat input due to a fire.

According to a preferred aspect of the present invention, the second protective layer is arranged and/or applied at least or exclusively to the flaps/tabs and/or overlap regions of the vacuum insulation panel and/or the second protective layer covers/protects the flaps/tabs and/or overlap regions from the outside. Preferably, an application of the second protective layer to the flaps/tabs and/or overlap regions increases the mechanical load-bearing capacity and the fire protection of the vacuum insulation panel. Namely, it has been found that the solutions known from the prior art with only one protective layer have reduced fire protection particularly at the flaps/tabs and/or overlap regions.

According to a preferred aspect of the present invention, the second protective layer is provided at least or exclusively at the edges and/or at the end faces and/or in the edge regions of the vacuum insulation panel and/or the enclosure, and/or the second protective layer forms the outer surface of the vacuum insulation panel and/or the enclosure at least or exclusively at the edges and/or at the end faces and/or in the edge regions.

In particular, the second protective layer can form an edge protection of the vacuum insulation panel and/or the enclosure.

In edge regions, there is an increased probability of damage to the vacuum insulation panel, for example due to large frictional forces.

Due to the manufacturing process, vacuum insulation panels may have flaps/tabs and/or regions/areas where a layer of the enclosure overlaps, hereinafter referred to as overlap regions. Increased damage, in particular delamination of the overlapping layers, can also occur at the flaps/tabs and/or in the overlap regions.

Further differences between the first protective layer and the second protective layer and/or special properties of the second protective layer compared with the first protective layer and vice versa, in particular with regard to their material properties, are discussed below, wherein this listing is not exhaustive.

The second protective layer preferably has a greater cohesive strength than the first protective layer.

The second protective layer preferably has a greater adhesive strength to the layer(s) immediately adjacent to the second protective layer than the first protective layer has to the layer(s) immediately adjacent to the first protective layer.

In the present invention, cohesive strength generally refers to the internal cohesion of a layer, i.e., the force per area that must be applied to cause a fracture in the layer and/or a layer break.

In the present invention, adhesive strength generally refers to the adhesion of two layers at their interface, i.e., the force per area that must be applied to cause separation of the layers and/or an interfacial fracture.

As already mentioned, the second protective layer has higher strength, in particular flexural strength, puncture resistance and/or abrasion resistance, higher stiffness, in particular flexural stiffness, greater hardness and/or higher thermal conductivity than the first protective layer.

In the present invention, the strength of a material generally refers to that stress which a component made of this material has under tensile stress at failure. To determine the strength of a material, a component made of that material, which is unified/standardized with respect to its geometric shape, dimensions and force application surface, is used. Preferably, the strength of a material is determined by means of the method described in DIN EN ISO 527-1:2019.

In the present invention, the flexural strength of a material generally refers to that stress which a component made of this material has under flexural stress at failure. To determine the flexural strength of a material, a component made of that material, which is unified/standardized with respect to its geometric shape, dimensions and flexural stress surface, is used. Preferably, the flexural strength of a material is determined by means of the method described in DIN EN ISO 14125:2011-05.

In the present invention, the abrasion resistance of a material generally refers to the resistance of a surface of this material to mechanical stress, in particular to friction. Preferably, under frictional stress with constant contact pressure, the same lateral frictional force and the same friction body, the geometric and/or molar layer abrasion/removal is lower for a layer with a higher abrasion resistance than for a layer with a lower abrasion resistance. Preferably, the abrasion resistance of a material is determined by means of the method described in DIN EN ISO 10545-7:1999-03.

In the present invention, the puncture resistance of a material generally refers to the stability of a material against a punctual mechanical load, for example from a pointed object. Preferably, the puncture resistance of a material is determined by means of the method described in DIN EN 14477:2004-06.

In the present invention, the thermal conductivity of a material generally refers to the rate at which the temperatures of two heat reservoirs approach each other when separated by the material.

By using the second protective layer, the first protective layer of the vacuum insulation panel can be made thinner than in vacuum insulation panels where only one protective layer is used, without affecting the heat resistance/fire resistance of the enclosure. In this way, manufacturing costs can be reduced.

Preferably, in the present invention, fire protection is understood to mean all measures that prevent and/or delay the development and spread of fire and/or fire damage and/or that counteract the development and spread of fire and/or fire damage.

Preferably, the fire protection requirements for a vacuum insulation panel are met if the vacuum insulation panel can be assigned to class B1, preferably A2, in particular A1, of DIN 4102-1:1998-05 and/or if the prerequisites/properties according to AITM 2.0053, AITM 2.0007B, AITM 3.0005 and/or AITM 2.0006 are met.

Preferably, the terms refractoriness, fire resistance, heat stability, thermal load-bearing capacity/resistance and/or heat resistance are used interchangeably.

Preferably, the second protective layer is bonded to the layer(s) immediately adjacent to the second protective layer.

Preferably, the second protective layer can be applied in a targeted manner, in particular in a single process step and/or in the final manufacturing step of the vacuum insulation panel.

Preferably, the second protective layer is applied or applicable by spraying, brushing and/or rolling—in particular over an area, to the edges and/or the flaps/tabs of the vacuum insulation panel.

As already mentioned, the second protective layer is preferably formed as a varnish and/or the first protective layer is preferably formed as a film/foil.

The first protective layer and/or the second protective layer can be formed in a single layer or in multiple layers, for example by multiple spraying, coating, rolling and/or winding/wrapping.

Due to the different properties and/or formations of the protective layers, the protective layers can work together synergistically, in particular when arranged smartly with respect to each other, especially preferably with respect to the thermal load-bearing capacity/resistance of the enclosure, the mechanical load-bearing capacity/resistance of the enclosure and/or the manufacturing costs of the vacuum insulation panel.

For example, the enclosure can have the first protective layer, in particular primarily, in the areas/regions and/or portions in which a large amount of heat is introduced into the vacuum insulation panel, for example in the event of a fire. Alternatively or additionally, the enclosure can have the second protective layer in the areas/regions and/or portions where large peeling forces and/or shearing forces act on the vacuum insulation panel.

According to a first embodiment and/or arrangement variant, the second protective layer is arranged at least in regions or over the entire surface—preferably directly—on the outside of the first protective layer and/or on a side of the first protective layer facing away from the core. In this embodiment or arrangement variant, the second protective layer thus forms the outermost layer and/or the outer side of the vacuum insulation panel and/or the enclosure.

As already mentioned, the second protective layer preferably, in particular in the first arrangement variant, distributes the forces acting on it, in particular a high surface load, which occurs for example in adhesive fastening at small contact areas, evenly to the immediately adjacent layer, in particular the first protective layer.

In this way, a lower surface load acts on the first protective layer in the first arrangement variant, so that greater peeling forces and/or shearing forces can be absorbed/sustained compared to the vacuum insulation panel disclosed in DE 10 2016 013 199 A1.

Preferably, compared to the vacuum insulation panel disclosed in DE 10 2016 013 199 A1, the first arrangement variant causes delamination of the first protective layer to occur later and/or not at all.

According to a second embodiment and/or arrangement variant, the second protective layer is arranged at least in regions or over the entire surface—preferably directly—on the outside of the barrier layer and/or the optional intermediate layer.

In the second embodiment or arrangement variant, the enclosure consequently has no first protective layer, at least in some regions.

Preferably, in the second embodiment or arrangement variant, the surface load that can be absorbed non-destructively by the vacuum insulation panel is increased compared to the first arrangement variant. The second arrangement variant is therefore particularly suitable for regions in which very large peeling forces and/or shearing forces act on the vacuum insulation panel and/or the enclosure, for example in regions in which two vacuum insulation panels are adhered to each other.

The first arrangement variant and the second arrangement variant can also be combined with one another, in particular in such a way that the vacuum insulation panel has the first arrangement variant or both the first and the second protective layer in some regions, for example on the flat sides, and the second arrangement variant or exclusively the second protective layer in some regions, for example on the end faces.

In particular, the second arrangement variant or exclusively the second protective layer can be provided in the region of the vacuum insulation panel in which one or more further vacuum insulation panel(s) and/or object(s) is/are fixed to the outer side, preferably in order to achieve a particularly large surface load that can be absorbed by the vacuum insulation panel non-destructively.

In regions of the vacuum insulation panel that form the outer surface of the vacuum insulation panel and/or of the arrangement in the usual state of use and/or in the assembled state of the vacuum insulation panel, the first arrangement variant or both the first and second protective layers are preferably provided so that increased heat resistance is achieved.

The first protective layer—like the second protective layer—can selectively be arranged, in particular adhered, in certain regions or partially or over the entire surface on the outside of the barrier layer and/or the intermediate layer.

As mentioned above, the first protective layer is preferably in the form of a film, the film being wrapped and/or adhesively bonded around the vacuum insulation panel and/or the core and/or the barrier layer in a partial, full-surface or overlapping manner during the manufacturing process.

According to a particularly preferred embodiment, the second protective layer is provided and/or applied at least in the overlapping regions of the first protective layer, which is in the form of a film, in particular in order to fix the overlapping film or film parts of the first protective layer.

In the case of a partial application of the first protective layer, it is in particular provided that the second protective layer fixes the individual film parts at their ends.

Preferably, in the case of a partial application of the first protective layer, the regions of the enclosure in which the enclosure does not have the first protective layer are provided and/or filled with the second protective layer, in particular in such a way that the second protective layer is arranged directly on the barrier layer or intermediate layer in these regions.

According to a particularly preferred embodiment, the first protective layer is applied in a pattern-like manner, for example in the form of stripes, dots or a mesh.

Preferably, a pattern-like application of the first protective layer enables a high cohesive strength, in particular when the outer surface of the vacuum insulation panel is large.

Preferably, the pattern-like applied first protective layer is covered, filled and/or stabilized by the second protective layer.

Preferably, in the regions where the second protective layer fills the pattern of the first protective layer, there is direct contact between the second protective layer on the one hand and the barrier layer and/or the intermediate layer on the other hand.

Such an embodiment advantageously has high cohesive strength and additionally meets the fire protection requirements for the vacuum insulation panel.

In addition, the pattern-like applied first protective layer and the second protective layer filling this pattern increase the surface roughness and thus the adhesion—for example of adhesive tapes or other fasteners—to the outer surface of the vacuum insulation panel.

The aspects and features of the present invention mentioned above and described below can be implemented independently of each other, but also in any combination.

Further advantages, features, characteristics and aspects of the present invention will be apparent from the claims and the following description of preferred embodiments with reference to the drawing. It shows:

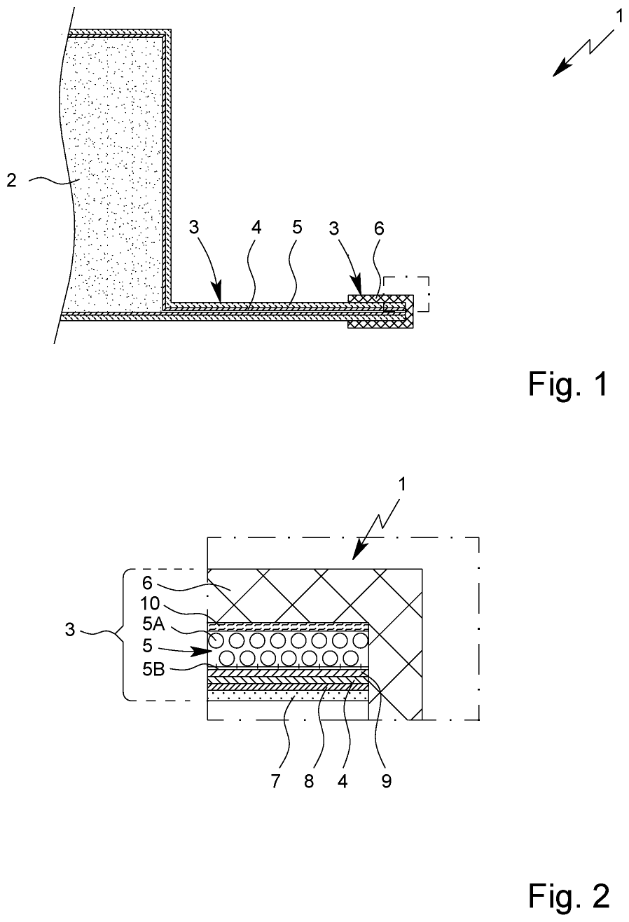

FIG. 1 a schematic partial section of a proposed vacuum insulation panel in an edge region;

FIG. 2 an enlarged detail of the dash-dotted region of the vacuum insulation panel according to FIG. 1;

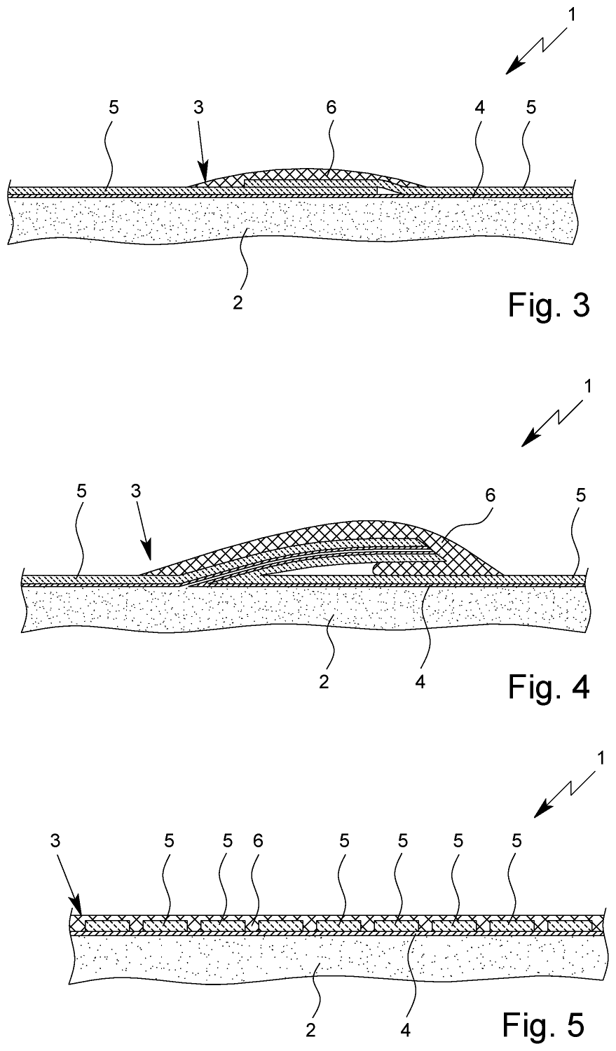

FIG. 3 a schematic partial section of the proposed vacuum insulation panel in an overlap region;

FIG. 4 a schematic partial section of the proposed vacuum insulation panel with folded flap; and

FIG. 5 a schematic partial section of the proposed vacuum insulation panel in accordance with a further embodiment.

In the figures, some of which are not to scale and are only schematic, the same reference signs are used for identical or similar parts, components and devices, resulting in the same or corresponding advantages and characteristics, even if a repeated description is omitted.

In the following, the basic structure of a proposed vacuum insulation panel 1 is first explained with reference to FIG. 1 and FIG. 2. FIGS. 3 and 4 show particular areas/regions of the vacuum insulation panel 1. FIG. 5 shows a further embodiment of the vacuum insulation panel 1.

The partial section shown in FIG. 1 shows the edge region of the proposed vacuum insulation panel 1 in accordance with a first embodiment. FIG. 2 shows an enlarged detail of the dash-dotted region of the vacuum insulation panel 1 according to FIG. 1.

However, the following explanations in connection with the embodiment shown in FIGS. 1 to 4 also apply accordingly to the embodiment shown in FIG. 5 and vice versa. In particular, the embodiment shown in FIG. 1 to FIG. 4 may have one, more or all features of the embodiment shown in FIG. 5 and vice versa.

The proposed vacuum insulation panel 1 may have different shapes and/or dimensions.

Usually, the vacuum insulation panel 1 is plate-shaped. However, the vacuum insulation panel 1 may also be curved, angled and/or have a thickness that changes over the length and/or width of the vacuum insulation panel.

Preferably, the vacuum insulation panel 1 has a core 2 and an envelope/enclosure 3, in particular a multilayer enclosure, which envelops/encloses the core 2 outwardly, on all sides and/or completely.

The enclosure 3 can in particular form a flap/tab (in each case) in the edge regions and/or on the end faces of the vacuum insulation panel 1. FIG. 1 shows a flap/tab formed by the enclosure 3 that is not (yet) folded/applied to the vacuum insulation panel 1.

In order to reduce the thermal conductivity of the core 2 and/or the vacuum insulation panel 1 and/or to improve the insulation properties of the vacuum insulation panel 1, the core 2 is evacuated or evacuable.

Preferably, the core 2 has or consists of an open-pored material, such as microporous silica powder.

Particularly preferably, the core is designed as explained in paragraphs three to seven of DE 10 2016 013 199 A1.

Preferably, the vacuum insulation panel 1, in particular the enclosure 3, has a gas-tight barrier layer 4, in particular wherein the evacuated state of the core 2 is maintained by the gas-tight barrier layer 4.

In the present invention, the term “gas-tight” is in particular understood to mean a permeation value of more than 10⁻¹⁰ mbar*l/s, in particular more than 10⁻⁹ mbar*l/s, and/or less than 10⁻⁷ mbar*l/s, in particular less than 10⁻⁸ mbar*l/s. The permeation value is preferably measured on the basis of water vapor rates and air transmission rates at the molecular level, as described in DIN 53380-3:1998 DE.

Particularly preferably, a layer is considered gas-tight if the air permeability is less than 20 mbar*l/(m²*y) or 6 mbar*l/(m²*y), especially preferably at least substantially 2 mbar*l/(m²*y), and/or the water vapor permeability is less than 0.05 g/(m²*day) or 0.03 g/(m²*day), particularly preferably at least substantially 0.02 g/(m²*day), preferably at an ambient temperature of 20° C. and an ambient pressure of 101.325 kPa. These permeabilities are measured according to the usual measurement methods of the state of the art.

The barrier layer 4 is preferably designed as a thin metallization or as a metal foil or as another foil. In particular, the barrier layer 4 has aluminum or consists thereof.

Preferably, the barrier layer 4 has a layer thickness of more than 5 μm, 10 μm or 30 μm and/or less than 100 μm or 70 μm. In particular, the barrier layer 4 has a layer thickness of at least substantially 50 μm.

Preferably, the barrier layer 4 is constructed and/or formed from two or more layer parts and/or foil pieces, in particular wherein the layer parts and/or foil pieces are placed against one another in a surrounding manner and/or are placed against one another in an overlapping manner and/or are connected to one another in a gas-tight manner.

The barrier layer 4 is preferably arranged directly or immediately on the core 2.

Preferably, the barrier layer 4 completely envelops the core 2, in particular in a gas-tight manner.

Preferably, the enclosure 3 has at least in some regions, in particular over the entire surface, a first heat-resistant protective layer 5 and/or at least in some regions, in particular over the entire surface, a second heat-resistant protective layer 6.

As explained at the outset, the vacuum insulation panel 1 achieves an improvement in mechanical stability/load-bearing capacity/resistance compared with the prior art, in particular an absorption of higher peeling forces and/or shearing forces, and/or an increase in thermal stability/load-bearing capacity/resistance and/or fire protection of the vacuum insulation panel 1.

Optionally, the vacuum insulation panel 1 and/or the enclosure 3 has an inner layer 7, a sealing layer 8, an intermediate layer 9 and/or a cover layer 10, preferably wherein the inner layer 7 and/or the sealing layer 8 are/is arranged between the barrier layer 4 and the core 2 and/or the intermediate layer 9 is arranged between the core 2, the inner layer 7, the sealing layer 8 and/or the barrier layer 4 on the one side and the first heat-resistant protective layer 5, the cover layer 10 and/or the second heat-resistant protective layer 6 on the other side.

Individual or all layers of the vacuum insulation panel 1, in particular the first heat-resistant protective layer 5 and/or the second heat-resistant protective layer 6, can (respectively) be formed as a single layer or as a multilayer.

DE 10 2016 013 199 A1 describes a plurality of possible structures of the enclosure 3, to which reference is made here. In particular, apart from the additional second protective layer 6, the enclosure 3 can be constructed as disclosed in DE 10 2016 013 199 A1 on pages four to five.

Preferably, the first heat-resistant protective layer 5, hereinafter referred to as the first protective layer 5, has particularly good thermal stability/load-bearing capacity/resistance compared to the second heat-resistant protective layer 6.

Preferably, the second heat-resistant protective layer 6, hereinafter referred to as second protective layer 6, has particularly good mechanical stability/load-bearing capacity/resistance compared to the first protective layer 5.

The first protective layer 5 and/or the second protective layer 6 are preferably arranged—directly or indirectly—on the outside of the barrier layer 4, the inner layer 7, the sealing layer 8, the intermediate layer 9 and/or the cover layer 10.

Preferably, the second protective layer 6 is arranged on the outside of the first protective layer 5 and/or the optional cover layer 10.

In particular, the second protective layer 6 forms—at least in some regions—the outermost layer of the vacuum insulation panel 1 and/or of the enclosure 3.

Preferred arrangements of the first protective layer 5, the second protective layer 6, the inner layer 7, the sealing layer 8, the intermediate layer 9 and/or the cover layer 10 will be discussed in more detail later.

Further differences between the first protective layer 5 and the second protective layer 6 and/or special properties of the second protective layer 6 compared with the first protective layer 5 and vice versa, in particular with regard to their material properties, are explained below, although this list is not exhaustive.

Preferably, the first protective layer 5 and/or the second protective layer 6 has or consists of a heat-resistant material.

The first protective layer 5 and the second protective layer 6 are preferably made of different heat-resistant (base) materials, as will be explained in more detail below. However, it is also possible in principle for the first protective layer 5 and the second protective layer 6 to be made from the same heat-resistant (base) material and/or to have (only) different additives, such as fillers.

In the present invention, the term “heat resistant” or “fire resistant” is preferably understood to mean the (thermal) stability/load-bearing capacity/resistance or ability of a material or component to withstand high temperatures, in particular of more than 250° C., 450° C. or 700° C., preferably for a duration of more than 5 minutes, 10 minutes or 30 minutes. The terms “heat resistant” and “fire resistant” are preferably to be understood as synonyms and are therefore interchangeable.

A material and/or component, in particular the first protective layer 5 and/or the second protective layer 6, is or are heat-resistant/fire-resistant in particular if it or they, at a use temperature of more than 250° C., preferably of more than 450° C., in particular of more than 700° C., preferably for a duration of more than 5 minutes, 10 minutes or 30 minutes, retains/retain its or their properties—for example the aggregate state, shape, strength, thermal conductivity or the like—or does/do not change them to such an extent that it/they is/are no longer suitable for the desired application(s) (here the protection of the vacuum insulation panel 1, preferably of all layers and/or materials covered by the protective layer 5 and/or 6, in particular of the core 2 and/or the barrier layer 4).

Preferably, a material or component, in particular the vacuum insulation panel 1, the first protective layer 5 and/or the second protective layer 6, is heat-resistant/fire-resistant if it or they meet the requirements for the fire behavior of building materials and building components according to DIN 4102-2|1977-09 and/or the fire resistance test according to DIN EN 1363-1|2020-05, in particular for a fire resistance duration of F30, F60, F90, F120 or F180 of one of these standards, and/or the requirements/properties according to AITM 2.0053, AITM 2.0007B, AITM 3.0005 and/or AITM 2.0006.

Preferably, the thermal conductivities of the first protective layer 5 and the second protective layer 6 are different.

Preferably, the thermal conductivity of the second protective layer 6 is greater than that of the first protective layer 5 by a factor of more than 1.5, in particular by a factor of more than 2.

Preferably, the thermal conductivity of the second protective layer 6 is greater than 0.001 W/(m*K), preferably greater than 0.01 W/(m*K) or 0.02 W/(m*K), and/or less than 1 W/(m*K), preferably less than 0.3 W/(m*K) or 0.1 W/(m*K).

Preferably, the thermal conductivity of the first protective layer 5 is greater than 0.0005 W/(m*K), preferably greater than 0.001 W/(m*K), and/or less than 0.1 W/(m*K), preferably less than 0.05 W/(m*K).

The first protective layer 5 has a longer fire resistance duration compared to the second protective layer 6.

Preferably, the fire resistance duration of the first protective layer 5 is greater than the fire resistance duration of the second protective layer 6 by a factor of 1.5, in particular by a factor of 2.

The thermal conductivity of the protective layer 5 and/or 6 is preferably decisive for the fire resistance duration, because as the thermal conductivity increases, the time within which a protective layer 5 and/or 6 gives off so much heat to an adjacent layer that the adjacent layer ignites and/or is destroyed decreases.

Due to the fact that the first protective layer 5 has a lower thermal conductivity than the second protective layer 6, the use of the first protective layer 5 in the present invention is particularly advantageous for meeting high fire protection requirements.

Preferably, the amount of material required, particularly in terms of volume, amount of substance, total cost of material, thickness and/or weight, to meet certain fire protection requirements is less for the first protective layer 5 than for the second protective layer 6.

In order to meet the fire protection requirements, it may therefore be more economical to form the first protective layer 5 in a thickness necessary for this purpose than the second protective layer 6 in a thickness necessary for this purpose.

Preferably, the first protective layer 5 has a mass per unit area of more than 5 g/m², in particular more than 25 g/m², and/or less than 200 g/m², in particular less than 100 g/m².

Preferably, the second protective layer 6 has a mass per unit area of more than 5 g/m², in particular more than 50 g/m², and/or less than 1000 g/m², in particular less than 500 g/m².

Preferably, the mass per unit area of the first protective layer 5 is greater than the mass per unit area of the second protective layer 6 by a factor of more than 1.5, in particular by a factor of more than 2.

Preferably, the second protective layer 6 has a density of more than 50 g/m³, in particular more than 150 g/m³, and/or less than 500 g/m³, in particular less than 300 g/m³.

Preferably, the first protective layer 5 has a thickness of more than 0.02 mm, in particular more than 0.05 mm, and/or less than 1 mm, in particular less than 0.15 mm.

Preferably, the thickness of the first protective layer 5 is greater than the thickness of the (unfoamed) second protective layer 6 by a factor of more than 1.5, in particular by a factor of more than 2.

The thickness or a change in the thickness of the second protective layer 6 due to heat input will be discussed later.

As already explained, the first protective layer 5 and/or the second protective layer 6 may be formed and/or applied only in certain regions/partially or over the entire surface.

The first protective layer 5 and/or the second protective layer 6 can thus cover the directly adjacent layer, in particular the barrier layer 4, the intermediate layer 9 and/or the cover layer 10, only in certain regions/partially or completely.

It has been found that when using the two protective layers 5 and/or 6, one or both of the protective layers 5 and/or 6 can be provided only in regions or partially in order to meet the fire protection requirements.

Preferably, the first protective layer 5 covers the majority, particularly preferably more than 60%, in particular more than 70%, and/or less than 98%, in particular less than 95%, of the vacuum insulation panel 1, in particular the barrier layer 4 and/or the intermediate layer 9.

Preferably, the first protective layer 5 forms the majority of the outer surfaces of the vacuum insulation panel 1 and/or of the enclosure 3, preferably more than 60%, in particular more than 70%, and/or less than 98%, in particular less than 95%.

As already mentioned, the second protective layer 6 is designed to protect the first protective layer 5 from external mechanical effects and/or to evenly distribute forces acting on it. In particular, the second protective layer 6 is stiffer and/or stronger/harder than the first protective layer 5.

Preferably, the second protective layer 6 is arranged, in particular directly, on the outside of the first protective layer 5.

Preferably, the puncture resistance of the second protective layer 6 is greater than 10 N, preferably greater than 15 N, and/or less than 100 N, preferably less than 50 N, in particular according to DIN EN 14477:2004-06.

Preferably, the flexural stiffness/rigidity of the second protective layer 6 is greater than that of the first protective layer 5 by a factor of more than 1.5, in particular by a factor of more than 2.

Preferably, the flexural stiffness of the first protective layer 5 is greater than 0.01 N*mm², preferably greater than 0.05 N*mm², and/or less than 10 N*mm², preferably less than 5 N*mm².

Preferably, the flexural stiffness of the second protective layer 6 is greater than 0.1 N*mm², preferably greater than 0.5 N*mm², and/or less than 20 N*mm², preferably less than 15 N*mm².

Due to the high flexural stiffness of the second protective layer 6, a force and/or surface load can be evenly distributed. Preferably, by means of the correct dimensioning and/or arrangement of the second protective layer 6, the force and/or surface load acting on the first protective layer 5 can be reduced to a level that does not destroy the first protective layer 5.

Preferably, the use of the second protective layer 6 increases the peeling forces and/or shearing forces that can be absorbed/sustained by the vacuum insulation panel 1 in a non-destructive manner.

Preferably, the peeling forces and/or shearing forces that can be absorbed/sustained non-destructively by the vacuum insulation panel 1 are increased by a factor of 1.5, in particular a factor of 2, compared to the vacuum insulation panel disclosed in DE 10 2016 013 199 A1.

Preferably, a vacuum insulation panel 1 can absorb/sustain a peeling force and/or shearing force of more than 50 N, preferably more than 100 N, particularly preferably more than 150 N, in a non-destructive manner.

Preferably, a vacuum insulation panel 1 can absorb/sustain a surface load of more than 10 N/m², preferably of more than 50 N/m², particularly preferably of more than 100 N/m², in a non-destructive manner.

Preferably, the cohesive strength of the second protective layer 6 is greater than that of the first protective layer 5 by a factor of more than 1.5, in particular by a factor of more than 2.

Preferably, the second protective layer 6 has a cohesive strength of more than 0.01 N/mm², in particular more than 0.1 N/mm², and/or less than 150 N/mm², in particular less than 100 N/mm².

Preferably, the first protective layer 5 has a cohesive strength of more than 0.005 N/mm², in particular more than 0.05 N/mm², and/or less than 75 N/mm², in particular less than 50 N/mm².

Preferably, the adhesive strength of the second protective layer 6 to the layer or layers directly adjacent to the second protective layer 6, in particular the first protective layer 5 and/or the cover layer 10, is greater by more than a factor of 1.5, in particular by more than a factor of 2, than the adhesive strength of the first protective layer 5 to the layer or layers directly adjacent to the first protective layer 5, in particular the cover layer 10, the intermediate layer 9 and/or the barrier layer 4.

Preferably, the second protective layer 6 has an adhesive strength to the layer or layers immediately adjacent to the second protective layer 6, in particular the first protective layer 5 and/or the cover layer 10, of more than 0.01 N/mm², in particular more than 0.1 N/mm², and/or less than 150 N/mm², in particular less than 100 N/mm².

Preferably, the first protective layer 5 has an adhesive strength to the layer or layers immediately adjacent to the first protective layer 5, in particular the cover layer 10, the intermediate layer 9 and/or the barrier layer 4, of more than 0.005 N/mm², in particular more than 0.05 N/mm², and/or less than 75 N/mm², in particular less than 50 N/mm².

In general, the holding together of multiple layers in the respective areas/regions of the vacuum insulation panel 1 and/or the enclosure 3 is only as strong as the smallest adhesive strength and/or cohesive strength of one and/or two layers, although this condition can be relativized by special layer arrangements. The first protective layer 5 is preferably more elastic than the second protective layer 6.

Preferably, with the same mechanical stress acting on the first protective layer 5 and second protective layer 6, the relative and/or absolute elongation/stretching of the first protective layer 5 is greater than that of the second protective layer 6 by more than a factor of 1.5, in particular by more than a factor of 2.

Preferably, the modulus of elasticity of the second protective layer 6 is greater than the modulus of elasticity of the first protective layer 5 by a factor of more than 1.5, in particular by a factor of more than 2.

Preferably, the first protective layer 5 has a modulus of elasticity of more than 1 MPa, in particular more than 5 MPa, and/or less than 10 GPa, in particular less than 5 GPa.

Preferably, the second protective layer 6 has a modulus of elasticity of more than 2 MPa, in particular more than 10 MPa, and/or less than 20 GPa, in particular less than 10 GPa.

In general, the modulus of elasticity of a material in the present invention denotes the ratio between applied uniaxial mechanical stress and the relative elongation/stretching of the material in the direction of the applied mechanical stress. To determine the modulus of elasticity of a material, a component made of that material that is unified/standardized with respect to its geometric shape, dimensions, and stress-applied surface is used. Preferably, the modulus of elasticity of a material is determined using the method described in DIN EN ISO 527-1:2012-06.

Preferably, the vacuum insulation panel 1 and/or the enclosure 3 has one of the protective layers 5 or 6 on the outside or in each region of its outer surface, which protects the vacuum insulation panel 1 from heat and/or a heat input.

Preferably, the second protective layer 6 forms the outer side or the outermost layer of the vacuum insulation panel 1 and/or of the enclosure 3 in those regions of the enclosure 3 in which the first protective layer 5 is not present, and the first protective layer 5 forms the outer side or the outermost layer of the vacuum insulation panel 1 and/or of the enclosure 3 in those regions of the enclosure 3 in which the second protective layer 6 is not present.

Preferably, the second protective layer 6 is provided at least in the (outer) regions of the vacuum insulation panel 1 and/or of the enclosure 3 in which particularly large peeling forces and/or shearing forces act on the vacuum insulation panel 1.

In particular, the second protective layer 6 is provided on (at least) the end faces, edges and/or flap of the vacuum insulation panel 1.

As illustrated in particular by FIG. 1, the second protective layer 6 is provided (at least) on the flap formed by the enclosure 3, particularly preferably on the (outer) edge of the flap formed by the enclosure 3.

Preferably, the first protective layer 5 has a different material or the first protective layer 5 consists of a different material than the second protective layer 6.

Preferably, the first protective layer 5 is in the form of a—in particular independently handleable—film/foil, in particular an adhesive film/foil and/or heavy film/foil, and/or is formed by enveloping/wrapping around the barrier layer 4 and/or the intermediate layer 9 once or multiple times.

Particularly preferably, the first protective layer 5 is fixed by material bonding, in particular by adhesive bonding, and/or is bonded to the barrier layer 4 and/or the intermediate layer 9.

Preferably, the first protective layer 5 comprises or consists of mica particles 5A, in particular wherein the mica particles 5A comprise or consist of phlogopite and/or muscovite as material.

Preferably, the first protective layer 5 has a sheet-like/planar carrier material 5B, in particular wherein the mica particles 5A are applied and fixed to the sheet-like carrier material 5B.

The carrier material 5B preferably has or consists of a woven or knitted glass fiber fabric or a film, particularly preferably made of plastic, in particular of polyethylene terephthalate.

Preferably, the first protective layer 5 and/or the carrier material 5B has a thickness of less than 100 μm, in particular less than 80 μm, and/or more than 1 μm, in particular more than 5 μm.

Preferably, the mica particles 5A are pre-fixed to the sheet-like carrier material 5B by a binder.

The carrier material 5B preferably forms an inner side/a side facing the core 2 of the first protective layer 5. The mica particles 5A fixed in the binder preferably form an outer side/a side facing away from the core 2 of the first protective layer 5.

In addition or alternatively to the mica particles 5A, the first protective layer 5 may comprise organic phosphinates, in particular wherein the first protective layer 5 comprises a polymer resin as a carrier material for the organic phosphinates.

As already explained, the second protective layer 6 is preferably arranged and/or fixed on the outside of the first protective layer 5 and/or on the outer side of the first protective layer 5. Particularly preferably, the second protective layer 6 thus acts as an additional fixing means of the mica particles 5A of the first protective layer 5.

In this way, the mechanical stability/load-bearing capacity and thus the lifetime of the first protective layer 5 and/or the vacuum insulation panel 1 is increased.

Preferably, the second protective layer 6 has mica particles, phlogopite, muscovite, H₂O admixtures, inorganic substances such as salts and/or oxides, glass fiber (without organic components) and/or intumescent materials such as exfoliated graphite.

Preferably, the second protective layer 6 is a varnish or adhesive, an adhesive tape, a heavy film/foil or a foam, in particular based on mica particles, phlogopite, muscovite and/or intumescent materials, such as exfoliated graphite.

Particularly preferably, the second protective layer 6 is an intumescent (fire protection) varnish, in particular with mica particles, phlogopite, muscovite, H₂O admixtures, inorganic substances such as salts and/or oxides, with glass fibers (without organic components) and/or exfoliated graphite.

The second protective layer 6 can in principle be constructed like the first protective layer 5 and/or be made of the same materials.

In particular, the second protective layer 6 may comprise or consist of mica particles, preferably wherein the mica particles comprise or consist of phlogopite and/or muscovite as material.

Preferably, the second protective layer 6 is materially bonded and/or inseparably connected to the adjacent layer(s), in particular the first protective layer 5, the intermediate layer 9 and/or the cover layer 10.

Preferably, the second protective layer 6 mixes in the interface region with the adjacent layer(s), in particular the first protective layer 5, the intermediate layer 9 and/or the cover layer 10.

Preferably, the second protective layer 6 is applicable or applied partially, preferably over the entire surface, to the first protective layer 5 and/or the barrier layer 4 by spraying, brushing, rolling, dipping and/or coating.

Preferably, the second protective layer 6 is applicable selectively/punctually, in particular in a single process step.

For example, the second protective layer 6 is applied at the outside on the flaps and/or edges of the vacuum insulation panel 1, in particular to enable or increase the fire protection of one or more flaps and/or edges of the vacuum insulation panel 1.

Preferably, the second protective layer 6 is liquid when applied.

Preferably, the second protective layer 6 in the liquid state and/or when applied—in particular at an ambient temperature of 25° C.—has a (dynamic) viscosity of more than 10 mPa*s, in particular more than 200 mPa*s, and/or less than 65000 mPa*s, in particular less than 6500 mPa*s.

Preferably, the second protective layer 6 in the liquid state and/or when applied—in particular at an ambient temperature of 25° C.—has a (dynamic) viscosity of more than 5 DIN-sec, in particular more than 8 DIN-sec and/or less than 40 DIN-sec, in particular less than 35 DIN-sec, preferably wherein the viscosity is determined in accordance with DIN EN ISO 2431:2020-02.

Preferably, the second protective layer 6 has a material or consists of a material that changes its volume when exposed to heat. In particular, the second protective layer 6 is intumescent.

In the present invention, the term “intumescent” generally describes—in particular with regard to fire protection—the expedient increase in volume (foaming, expansion, swelling/inflating) of a substance in order to obtain properties useful for fire protection.

Preferably, intumescence is based on the inclusion/intercalation of molecules between lattice planes, wherein the included/intercalated molecules preferably under the influence of heat evaporate and thereby drive the crystal lattice apart.

Preferably, the second protective layer 6 has exfoliated graphite/expandable graphite as material or consists thereof.

Preferably, the second protective layer 6—in its original and/or non-heated/expanded/foamed state—has a thickness of more than 0.001 mm, in particular more than 0.05 mm, and/or less than 1 mm, in particular less than 0.3 mm.

Preferably, the second protective layer 6 in the heated/expanded/foamed state has a thickness of more than 0.1 mm, in particular more than 0.5 mm or 1 mm, and/or less than 15 mm, in particular less than 9 mm.

Preferably, the second protective layer 6 increases its thickness due to the action of heat and/or the expansion/foaming by more than 30%, in particular by more than 50%, and/or by less than 300%, in particular by less than 200%,

Preferably, the relative change in the geometric dimensions—in particular the thickness, height and width—of the second protective layer 6 is anisotropic due to an expansion/foaming thereof. Preferably, the maximum relative change in the geometric dimensions of the second protective layer 6 is carried out by expansion/foaming thereof in a direction that is oriented at least substantially perpendicular to a main extension plane of the second protective layer 6.

Preferably, two protective layers 5, 6 increase the lifetime of the vacuum insulation panel 1.

Preferably, the two protective layers 5, 6 increase the water vapor barrier of the vacuum insulation panel 1. Due to a higher water vapor barrier, the inner layers are exposed to lower external aging processes.

In the following, preferred arrangements of the first protective layer 5, the second protective layer 6, the inner layer 7, the sealing layer 8, the intermediate layer 9 and/or the cover layer 10 are discussed in more detail.

Preferably, the first protective layer 5 and/or the second protective layer 6 are arranged on the outside of the barrier layer 4 in at least one region, as already mentioned.

The first protective layer 5 and/or second protective layer 6 do not necessarily have to be arranged directly on/at the outside of the barrier layer 4. The protective layers 5, 6 can additionally and/or alternatively be arranged on/at the outside of the inner layer 7, sealing layer 8, intermediate layer 9 and/or the cover layer 10.

FIG. 2 shows a possible layered structure of the enclosure 3 in detail. The enclosure 3 is shown in simplified form in the other figures for reasons of clarity, but can also have one, multiple or all of the layers shown in FIG. 2.

According to a first arrangement variant, the second protective layer 6 is arranged directly on the outside of the first protective layer 5, in particular on the side of the first protective layer 5 facing away from the core 2.

The first arrangement variant preferably results in a lower surface load acting on the first protective layer 5. In particular, the second protective layer 6 can even out and/or distribute a (punctual) load on the first protective layer 5.

A lower load on the first protective layer 5 preferably leads to a later and/or not at all occuring delamination of the first protective layer 5.

According to a second arrangement variant, the second protective layer 6 is arranged directly on the outside of the barrier layer 4, in particular on the side of the barrier layer 4 facing away from the core 2, in particular in order to increase the surface load that can be absorbed by the vacuum insulation panel 1 in a non-destructive manner compared to a positioning according to the first arrangement variant.

Preferably, the second protective layer 6 forms the outer surface of the vacuum insulation panel 1 at least in the edge regions and/or at the end faces of the vacuum insulation panel 1 and/or the second protective layer 6 is provided at least in the edge regions and/or at the end faces of the vacuum insulation panel 1.

In particular, the second protective layer 6 can form an edge protection of the vacuum insulation panel 1. Namely, in the edge regions, there is usually an increased probability of damage to the vacuum insulation panel 1.

The two arrangement variants described above can also be combined with each other, for example in edge regions of the vacuum insulation panel 1.

As illustrated in particular in FIG. 2, both the first protective layer 5 and the second protective layer 6 are provided on the flat sides at least edge-sided or at the edges of the vacuum insulation panel 1. On the end face(s), preferably only the second protective layer 6 is provided and/or the second protective layer 6 is directly attached to the barrier layer 4 or the optional intermediate layer 9.

In the installed state (not shown), multiple vacuum insulation panels 1 can be fixed to each other at the end faces. In particular, multiple vacuum insulation panels 1 can be fixed to each other in such a way that they enclose an object, such as a wall, flush, preferably completely, and/or insulate it from the outside.

Large surface loads and/or large peeling forces and/or shearing forces can therefore act on the respective vacuum insulation panels 1 at the end faces and/or in the fixing regions.

On the other hand, the heat input into the vacuum insulation panel 1 is lower on the end faces and/or in the fixing region than on the flat sides of the vacuum insulation panel 1.

It is therefore provided that—as already explained—the end face and/or the fixing region of the vacuum insulation panel 1 is optimized in terms of mechanical stability/load-bearing capacity/resistance by exclusive use of the second protective layer 6 or omission of the first protective layer 5.

Preferably, the second protective layer 6 is arranged directly on the barrier layer 4 or the optional intermediate layer 9 at the end face and/or in the fixing region. In particular, at the end face and/or in the fixing region, only the second protective layer 6 of the two protective layers 5, 6 is provided, thus the second arrangement variant is implemented.

Preferably, the flat sides of the vacuum insulation panel 1 and/or the regions forming the flat/planar outer sides are optimized in terms of thermal stability/load-bearing capacity/resistance.

In particular, on the flat side or the flat/planar outer side of the vacuum insulation panel 1, both the first protective layer 5 and the second protective layer 6 are provided, thus the first arrangement variant is implemented.

The structure of the enclosure 3 can consequently be adapted in certain areas/regions—depending on the intended use of the vacuum insulation panel 1.

The aforementioned intermediate layer 9 preferably serves to protect the barrier layer 4.

Preferably, the intermediate layer 9 has or consists of polyethylene terephthalate.

Preferably, the intermediate layer 9 is arranged directly on the side of the barrier layer 4 facing away from the core 2 and/or on the side of the first protective layer 5 facing the core and/or on the side of the second protective layer 6 facing the core 2.

Preferably, the intermediate layer 9 has a thickness of less than 50 μm and/or more than 1 μm.

Preferably, the sealing layer 8 seals layer parts and/or film/foil pieces of the barrier layer 4, in particular gas-tight.

Preferably, the sealing layer 8 has or consists of plastic, in particular polyethylene, polypropylene or ethylene-vinyl alcohol copolymer.

Preferably, the sealing layer 8 has a thickness of less than 100 μm or 70 μm and/or more than 10 μm, in particular more than 20 μm. In particular, the sealing layer 8 has a thickness of at least substantially 50 μm.

The sealing layer 8 is preferably arranged, in particular directly arranged, on the side of the barrier layer 4 facing the core.

The sealing layer 8 is either directly adjacent to the core 2 and/or on the side of the barrier layer 4 facing the core 2.

Preferably, the inner layer 7 prevents leakage of the core material at the beginning of the production of the vacuum insulation panel 1, in particular if the core material is microporous.

Preferably, the inner layer 7 has or consists of woven or knitted plastic fabric or paper. This material is very well suited for the function described above.

Preferably, the inner layer 7 has a thickness of less than 100 μm, in particular less than 80 μm, and/or more than 1 μm, in particular more than 5 μm.

Preferably, the inner layer 7 is arranged on the side of the barrier layer 4 facing the core 2 and/or on the side of the sealing layer 8 facing the core 2.

Preferably, the cover layer 10 prevents and/or makes it more difficult for the enclosure 3 to tear/crack/rupture when exposed to flames.

Preferably, the mica particles 5A of the first protective layer 5 are covered by the cover layer 10.

Preferably, the cover layer 10 has or consists of glass fibers.

Preferably, the cover layer 10 is arranged directly on the side of the first protective layer 5 facing away from the core 2.

Optionally, the second protective layer 6 acts as a cover layer 10.

The first protective layer 5 can be applied in a partially overlapping manner or have at least one overlapping region, in particular when designed as a film/foil, as shown schematically in FIG. 3.

Preferably, the overlapping film parts of the first protective layer 5 are fixed to each other at their interface with an adhesive, in particular a heat-resistant/fire-resistant adhesive.

Preferably, the first protective layer 5, designed as a film, is materially bonded to the layer immediately adjacent on the inside and/or outside.

Preferably, the overlap region of the first protective layer 5 is covered and/or reinforced with the second protective layer 6, in particular to protect the overlap region from external mechanical effects and/or to prevent delamination.

Particularly preferably, the second protective layer 6 is directly connected and/or adhesively bonded to the first protective layer 5 in the overlap region.

As already explained at the outset, the vacuum insulation panel 1, in particular the enclosure 3, can have or form one or more flaps/tabs, preferably wherein the flap(s) is/are folded/bent onto the vacuum insulation panel 1, in particular onto the end faces of the vacuum insulation panel 1, in particular in such a way that the vacuum insulation panel 1 and/or the enclosure 3 does not have or form any protruding regions, as illustrated in FIG. 4.

The flap may have the first protective layer 5 only partially on the side facing away from the core 2.

Preferably, the flap is completely or partially covered and/or reinforced and/or adhesively bonded with the second protective layer 6.

As explained in connection with FIG. 1, preferably at least the (outer) edge of the flap is provided with the second protective layer 6. However, it is also possible for the flap to be covered by the second protective layer 6 toward the outside over its entire surface, as illustrated in FIG. 4.

In addition, the second protective layer 6 can at least partially fill undercuts, gaps, cavities or the like formed by the tab, in particular in such a way as to reduce the risk of detachment of the flap and/or damage to the vacuum insulation panel 1 at this location.

FIG. 5 shows a further preferred embodiment of the vacuum insulation panel 1, in which the first protective layer 5 is provided only in areas/regions and/or, in particular, does not completely cover the barrier layer 4.

Preferably, in the embodiment shown in FIG. 5, the first protective layer 5 is applied only partially, in particular in a pattern-like manner, preferably in the form of stripes, dots, nets or other patterns.

Preferably, the entire enclosure 3 has the partially and/or pattern-like applied first protective layer 5. However, it is also possible that only the flat side or the flat/planar outer side of the enclosure 3 and/or the vacuum insulation panel 1 has the partial and/or pattern-like protective layer 5.

Preferably, the applied first protective layer 5 is fixed and/or filled and/or completely covered by the second protective layer 6.

In particular, the second protective layer 6 stabilizes the pattern of the first protective layer 5.

Optionally, the second protective layer 6 is (also) applied only partially, in particular in a pattern-like manner, preferably in the form of stripes, dots, nets or other patterns.

Preferably, when the second protective layer 6 and the first protective layer 5 are applied in a pattern-like manner, the enclosure 3 has at least one protective layer 5, 6 in each region.

Preferably, there is direct contact between the second protective layer 6 and the barrier layer 4 and/or the intermediate layer 9 in the regions where the second protective layer 6 fills free spaces and/or gaps in the first protective layer 5.

By this structure, the surface roughness of the outer side of the vacuum insulation panel 1 is advantageously increased, in particular in such a way that multiple vacuum insulation panels 1 can be fixed to each other, in particular adhered/glued to each other, on their outer sides.

In addition, the mechanical stability/load-bearing capacity of the enclosure 3 is increased without disproportionately affecting the fire resistance/fire protection capability of the vacuum insulation panel 1.

Individual features and aspects of the present invention can be combined as desired, but can also be implemented independently.

### LIST OF REFERENCE SIGNS

1 Vacuum insulation panel

2 Core

3 Enclosure

4 Barrier layer

5 First protective layer

5A Mica particles

5B Carrier material

6 Second protective layer

7 Inner layer

8 Sealing layer

9 Intermediate layer

10 Cover layer

1-15. (canceled)

16. A vacuum insulation panel with a core of open-pore material and a gas-tight enclosure completely enclosing the core on all sides,
wherein the enclosure has a gas-tight barrier layer,
wherein the enclosure has, at least in regions, a first protective layer which comprises or consists of a first heat-resistant material and is arranged on the outside of the barrier layer and/or on an intermediate layer located on the outside of the barrier layer,
wherein the enclosure has, at least in regions, a second protective layer comprising or consisting of a second heat-resistant material, and
wherein the second protective layer is arranged on at least one of: the outside of the barrier layer, an intermediate layer located on the outside of the barrier layer, the outside of the first protective layer, or a cover layer located on the outside of the first protective layer.

17. The vacuum insulation panel according to claim 16, wherein the enclosure has at least one of the first protective layer or second protective layer over its entire surface.

18. The vacuum insulation panel according to claim 16, wherein the first protective layer comprises mica particles.

19. The vacuum insulation panel according to claim 18, wherein the mica particles comprise or consist of phlogopite and/or muscovite as material.

20. The vacuum insulation panel according to claim 18, wherein the mica particles of the first protective layer are applied and fixed on a sheet-like carrier material.

21. The vacuum insulation panel according to claim 20, wherein the sheet-like carrier material is a woven or knitted glass fiber fabric or a plastic film, and/or wherein the mica particles are fixed or prefixed on the sheet-like carrier material by a binder.

22. The vacuum insulation panel according to claim 18, wherein the mica particles of the first protective layer are covered by an outer cover layer which prevents or at least impedes cracking of the enclosure when exposed to flame.

23. The vacuum insulation panel according to claim 22, wherein the cover layer comprises glass fibers.

24. The vacuum insulation panel according to claim 16, wherein the second protective layer covers the first protective layer in edge regions and/or overlap regions and/or wherein the enclosure or the vacuum insulation panel has the second protective layer in edge regions and/or overlap regions.

25. The vacuum insulation panel according to claim 16, wherein the first protective layer is arranged only in regions on the outside of the barrier layer and/or on an intermediate layer located on the outside of the barrier layer, and the enclosure has the second protective layer in the regions in which the first protective layer is not present.

26. The vacuum insulation panel according to claim 16, wherein the second protective layer is applicable or applied by at least one of spraying, brushing, rolling, dipping, or coating.

27. The vacuum insulation panel according to claim 16, wherein the second protective layer is liquid when applied.

28. The vacuum insulation panel according to claim 16, wherein the second protective layer comprises or consists of a material which changes its volume when exposed to heat, and/or wherein the second protective layer is intumescent.

29. The vacuum insulation panel according to claim 16, wherein the second protective layer is a varnish, adhesive, adhesive tape or foam.

30. The vacuum insulation panel according to claim 16, wherein the second protective layer comprises or consists of exfoliated graphite as material.

31. The vacuum insulation panel according to claim 16, wherein the second protective layer has a thickness of more than 0.001 mm and/or less than 1 mm.

32. The vacuum insulation panel according to claim 16, wherein the second protective layer comprises or consists of one or more different materials than the first protective layer.

33. The vacuum insulation panel according to claim 16, wherein the second protective layer has a greater cohesive strength and/or adhesive strength than the first protective layer.

34. The vacuum insulation panel according to claim 16, wherein the first protective layer is designed as an independently handleable film.

35. The vacuum insulation panel according to claim 34, wherein the first protective layer is bonded to at least one of the barrier layer, the intermediate layer, the cover layer, or the second protective layer and/or wherein the first protective layer is applied in a partially overlapping manner.
